(19) United States
(12) Patent Application Publication
(10) Pub. No.: US 2017/0063094 A1
(43) Pub. Date: Mar. 2, 2017

(54) POWER PROCESSING

(71) Applicant: SunPower Corporation, San Jose, CA (US)

(72) Inventors: Patrick L. Chapman, Austin, TX (US); Jonathan L. Ehlmann, Austin, TX (US)

(73) Assignee: SunPower Corporation, San Jose, CA (US)

(21) Appl. No.: 14/837,118

(22) Filed: Aug. 27, 2015

(51) Int. Cl. H02J 3/38; H02M 7/44

(52) U.S. Cl. CPC H02J 3/383; H02M 7/44

(57) ABSTRACT

Differential power processing (DPP) converters are used within circuit architecture of solar power modules to process the mismatched power between solar elements in a power module. The DPP converters use various topologies to process the mismatched power. These topologies can include a housekeeping power supply where the housekeeping power is coupled to the main bus, or, through various other tapping topologies, including to a subset of PV cell substrings.

This invention was made with government support under DE-AR0000217 awarded by The U.S. Department of Energy. The government has certain rights in the invention.

### BACKGROUND

Photovoltaic (PV) cells, commonly known as solar cells, are devices for conversion of solar radiation into electrical energy. Generally, solar radiation impinging on the surface of, and entering into, the substrate of a solar cell creates electron and hole pairs in the bulk of the substrate. The electron and hole pairs migrate to p-doped and n-doped regions in the substrate, thereby creating a voltage differential between the doped regions. The doped regions are connected to the conductive regions on the solar cell to direct an electrical current from the cell to an external circuit. When PV cells are combined in an array such as a PV module, the electrical energy collected from all of the PV cells can be combined in series and parallel arrangements to provide power with a certain voltage and current.

Module-level power electronics converters, i.e., MLPE converters, such as a dc-dc optimizer, can conduct maximum power point tracking (MPPT) of individual PV modules, or possibly substrings of PV cells. These MLPEs may include dc-dc optimizers that process 100% of the power being generated and housekeeping circuits that provide power to various circuits. Differential power processing (DPP) may be used in conjunction with maximum power point tracking (MPPT) to process power mismatch among PV cells. This power match feature can serve to correct for mismatches in maximum power point (MPP) current that would otherwise occur in series-connected PV cells.

### BRIEF DESCRIPTION OF THE DRAWINGS

FIG. 1 illustrates an example block diagram of PV power module having a PV-to-bus module converter, according to some embodiments.

FIG. 2 illustrates a circuit diagram showing a PV-to-bus converter topology, according to some embodiments.

FIG. 3 illustrates a circuit diagram showing a PV-to-bus converter topology, according to some embodiments.

FIGS. 4A and 4B illustrate a circuit diagram showing a PV-to-bus converter topology, according to some embodiments.

FIG. 5A illustrates a circuit diagram showing a PV-to-bus converter topology, according to some embodiments.

FIG. 5B illustrates a circuit diagram showing a PV-to-bus converter topology.

FIG. 6 illustrates a circuit diagram showing a PV-to-bus converter topology, according to some embodiments.

FIG. 7 illustrates a circuit diagram showing a PV-to-bus converter topology, according to some embodiments.

FIG. 8 illustrates a flowchart showing a method for converting differential power within a plurality of PV cell substrings, according to some embodiments.

FIG. 9 illustrates a flowchart showing a method for supplying power to a housekeeping power supply within a converter topology, according to some embodiments.

### DETAILED DESCRIPTION

The following detailed description is merely illustrative in nature and is not intended to limit the embodiments of the subject matter of the application or uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Terminology. The following paragraphs provide definitions and/or context for terms found in this disclosure (including the appended claims):

“Comprising.” This term is open-ended. As used in the appended claims, this term does not foreclose additional structure or steps.

“Configured To.” Various units or components may be described or claimed as “configured to” perform a task or tasks. In such contexts, “configured to” is used to connote structure by indicating that the units/components include structure that performs those task or tasks during operation. As such, the unit/component can be said to be configured to perform the task even when the specified unit/component is not currently operational (e.g., is not on/active). Reciting that a unit/circuit/component is “configured to” perform one or more tasks is expressly intended not to invoke 35 U.S.C. §112, sixth paragraph, for that unit/component.

“First,” “Second,” etc. As used herein, these terms are used as labels for nouns that they precede, and do not imply any type of ordering (e.g., spatial, temporal, logical, etc.). For example, reference to a “first” solar cell does not necessarily imply that this solar cell is the first solar cell in a sequence; instead the term “first” is used to differentiate this solar cell from another solar cell (e.g., a “second” solar cell). Likewise, a first PV module does not necessarily imply that this module is the first one in a sequence, or the top PV module on a panel. Such designations do not have any bearing on the location of the PV module, substrings, and the like.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

“Coupled”—The following description refers to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically.

“Inhibit”—As used herein, inhibit is used to describe a reducing or minimizing effect. When a component or feature is described as inhibiting an action, motion, or condition it may completely prevent the result or outcome or future state completely. Additionally, “inhibit” can also refer to a reduction or lessening of the outcome, performance, and/or effect which might otherwise occur. Accordingly, when a component, element, or feature is referred to as inhibiting a result or state, it need not completely prevent or eliminate the result or state.

In addition, certain terminology may also be used in the following description for the purpose of reference only, and thus are not intended to be limiting. For example, terms such as “upper”, “lower”, “above”, and “below” refer to directions in the drawings to which reference is made. Terms such as “front”, “back”, “rear”, “side”, “outboard”, and “inboard” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import.

In the following description, numerous specific details are set forth, such as specific operations, in order to provide a thorough understanding of embodiments of the present disclosure. It will be apparent to one skilled in the art that embodiments of the present disclosure may be practiced without these specific details. In other instances, well-known techniques are not described in detail in order to not unnecessarily obscure embodiments of the present disclosure.

This specification describes exemplary PV-to-bus architectures that can include the disclosed DPP converter implementations, followed by a more detailed explanation of various embodiments of the DPP converter topologies. The specification also includes a description of exemplary methods. Examples of housekeeping power supplies according to embodiments are also provided in the specification, these housekeeping power supplies have numerous implementations, including the various examples provided throughout.

In embodiments, DPP converters may process the mismatch in power between PV modules or cells or strings or substrings, rather than the total power of a PV module (or substring or any collection of PV cells that would otherwise be connected according to an arrangement, such as being connected in series). DPP converters can be of benefit because the mismatches may generally be small and because of this relatively small mismatch, sometimes on the order of 1%-20% or more, a relatively small correction can be required.

In embodiments, DPP converters can allow the bulk of current from a PV module to pass directly to neighboring modules via wires as opposed to flowing the current through a converter. This process may be considered efficient because in so doing only mismatch current can flow through the DPP converters. For example, if two modules connected in series may have I_MPP currents of 5 amperes (A) and 6 A, respectively. The mismatch current may be 1 A. If the two modules are connected in series, then the modules are forced to carry the same current, which may not be optimal for either module. In this example, each of the DPP converters preferably provides a path for 0.5 A of the mismatch current. Because the mismatch currents are relatively small, a DPP converter can preferably be capable of low-current/low-power operation. This low current/low power operation may be considered an improvement over dc-dc optimizers that carry full current and full power operation.

Architectures of embodiments may include many configurations. One configuration is the PV-to-PV architecture, which can use a buck-boost topology. Another configuration may be a PV-to-bus architecture. In the PV-to-PV architecture, when the individual converters have a blocking voltage of two PV modules the DPP converters are connected to neighboring nodes. For PV-to-bus architectures, the DPP converters serve to block the entire string voltage, even though their inductors may carry less current. In addition, for PV-to-bus architectures, the DPP converters can be coupled at each source where the output may go to a centralized point or line as opposed to and from one PV string to another. For example, the DPP converters may be connected to a shared bus as a centralized line. Alternatively, the DPP converters may be connected to a virtual bus. One of ordinary skill in the art would recognize that the PV-to-bus architecture shown in some embodiments is just representative, and that, more generally, the use of a “virtual bus” is known. In embodiments, the PV-to-bus architectures may also use a circuit implementation having a flyback differential converter interface with the main bus.

Embodiments can include a DC power system that includes a PV power converter circuit and a PV module having a plurality of PV cells arranged in strings and substrings. The PV cells in the substrings of the PV module may preferably be arranged in series. Other arrangements, however, may be used according to the disclosed embodiments. The PV power system may include a central converter coupled to the PV module by a shared bus as well as local converters serving individual PV modules. Individual PV modules as well as the PV power system as a whole may include several DPP converter circuits, where the DPP converter circuits are coupled to a shared bus and two or more shared PV cell strings or substrings. The bus may be a virtual bus, in some embodiments. The PV power system may have multiple DPP converter circuits where each DPP converter circuit is coupled to two PV cell substrings of a PV module such that each of the DPP converter circuits processes a difference in power between the coupled PV cell substrings. These DPP converter circuits may further provide the processed power difference to a local or central converter via a shared bus. In embodiments, a DPP converter circuit may include two switches and an inductor where the inductor may be coupled directly to a plurality of PV cell substrings in the absence of a bypass diode. Still further, DPP converter circuits of embodiments may be positioned and configured to shuffle power between strings, substrings, cells, or other groupings or dc power sources depending upon how the DPP converter circuits are tapped to these voltage sources.

In embodiments, DPP converter circuits may be configured without discrete inductors. Instead, the parasitic/stray inductances, Ls, of a PV module may be relied upon for converter inductance. While these inductances are ordinarily small (<<1 mH), they can be adequate for a sufficiently high switching frequency DPP converter circuit switches. Moreover, using diodes for top switches rather than actively switched power MOSFETs may allow the use of discontinuous converter modes. These diodes may be part of MOSFETs turned off for such implementation. While such modes may generate unwanted current ripple in the sources (the ripple in inductances, Ls, would be high, in other words), this may not be necessarily problematic as the relatively high capacitance of solar cells may be used to absorb high frequency current ripple, resulting in manageable lost PV power production. A possible advantage of discrete inductor elimination may include cost, space, and weight savings. And, even though efficiency may not be as high for the DPP converter circuits without dedicated inductors, DPP converter circuits of embodiments may not need to conduct large amounts of power, therefore reducing the relative importance of their efficiency.

Embodiments may also include a PV power converter circuit that includes a housekeeping “HK” power supply “HKPS” powered at least in part by one or several of the PV cells of a PV module. These housekeeping power supplies may have various output voltages to power components such as op-amps, sensors, and microcontrollers on low voltage outputs, e.g., 3.3 V and gate drivers on higher voltage outputs, e.g., 8 V. These housekeeping power supplies may be tapped into various points of these PV systems such that the housekeeping power supplies receive supply power from various circuit configurations, including various numbers of PV cells in embodiments and from one or more converters in the same circuit or elsewhere.

Multiple PV sources may be employed in embodiments, for example, substrings of a PV module may each be considered a PV source. In embodiments, transistor diode pairs, which may be built from power MOSFETS, may be employed as switches and configured with two inductors such that two bidirectional converter circuits are formed. These bi-directional converter circuits can exchange power from PV sources to and from a shared bus. In addition, this bidirectional configuration and operation can allow for adjustment of individual PV substring voltages.

In certain embodiments, inductor, transistor and diode sets may be configured to serve as converter circuits where the diodes may be positioned such that the converter circuits are unidirectional. Such an arrangement can reduce or eliminate the need to provide a high-side gate drive to a top switch. Such an arrangement may also result in one of the converter circuits having its output as the input of another converter circuit rather than a shared bus. In so doing, a converter circuit without bus output may not experience as high of voltage stresses as other converter circuits in the system that are outputting to a shared bus. Inherent bypass diode protection may also be provided as PV sources in these embodiments may employ parallel diode for DC currents where related inductors can be treated as short circuits.

In embodiments, further electrical isolation may be provided by replacing the inductors with transformers. The primary winding of these transformers may provide the main inductance needed for power conversion whereas the secondary winding, may provide a low or different voltage output and may be steadied or rectified through subsequent treatment by diodes, capacitors or other treatment device. Also, inductive cores may have extra windings and be coupled to housekeeping power supplies or another inductor where either can serve as a power supply for a housekeeping circuit.

In embodiments, low voltage outputs may be used to power housekeeping circuits. These housekeeping circuits may be positioned near and powered by these low power outputs to promote efficiency and reduce circuit complexity when compared to a housekeeping circuit that was fed by a full PV module voltage of other full DC power system voltage. For example, a housekeeping circuit, normally composed of a high-input-voltage switching power supply may potentially be replaced by a low-cost linear regulator. Thus, in embodiments, even if a switching power supply is still used, it may be fed from a lower voltage and in so doing may have inherently lower cost and be more efficient. Still further, in embodiments, housekeeping power could also be, or alternatively be, fed with full PV panel voltage via a second circuit network as a default so that housekeeping power is continuous, if not efficient. Still further, the power supplies for the housekeeping power, e.g., low voltage partial circuits, high voltage full PV circuits, PV string source lead, etc., could be used only during normal operation or as needed depending on efficiency and availability. In preferred embodiments however, housekeeping power can be fed off of a lower voltage supply.

Other power sources and sequential power adaptations for a housekeeping power supply are also covered in embodiments. For example, different PV strings may be used to power the housekeeping power supply to accommodate for certain shading conditions or when voltages from some sources are low while voltages from other sources are normal or high. Thus, in embodiments, a network of resistors, diodes, and an analog switch may be employed to select available PV sources and to actually connect the available source to the input of the housekeeping supply. The resistors in these circuits may be sized to ensure that if a first PV source reduces in voltage (say below 8 V), then the sum of other PV sources is applied to the housekeeping input, enabling the housekeeping supply to remain on and still powered by a relatively low voltage.

Embodiments may also power the housekeeping supply though the use of dedicated PV cell(s). These dedicated “housekeeping cell(s)” may be brought out of the module for the express purpose of powering the housekeeping supply. The housekeeping cell or cells may or may not employ the standard large (5″ or 6″, typical) PV cell. In embodiments the housekeeping cell(s) may be smaller than standard cells and may be placed among the standard cells expressly for this purpose, taking advantage of the lower power demands of the housekeeping supply. When single cells are used a dc-dc converter may be used to step up the voltage from 0.5 V to 3.0 V. This dedicated HKPS configuration, as with other embodiments, may be synthesized with the DPP approach or other j-box integrated electronics and in so doing providing access to sub-module electrical nodes. For example, housekeeping power from another source can be turned on if power from a primary source such as a cell or substring became unavailable. Moreover, this alternative cell approach may be used to accommodate self shading scenarios where housekeeping cells become shaded during certain periods of the day depending upon their positioning. In these self-shading time periods backup or alternative housekeeping cells may be used to power the housekeeping supply.

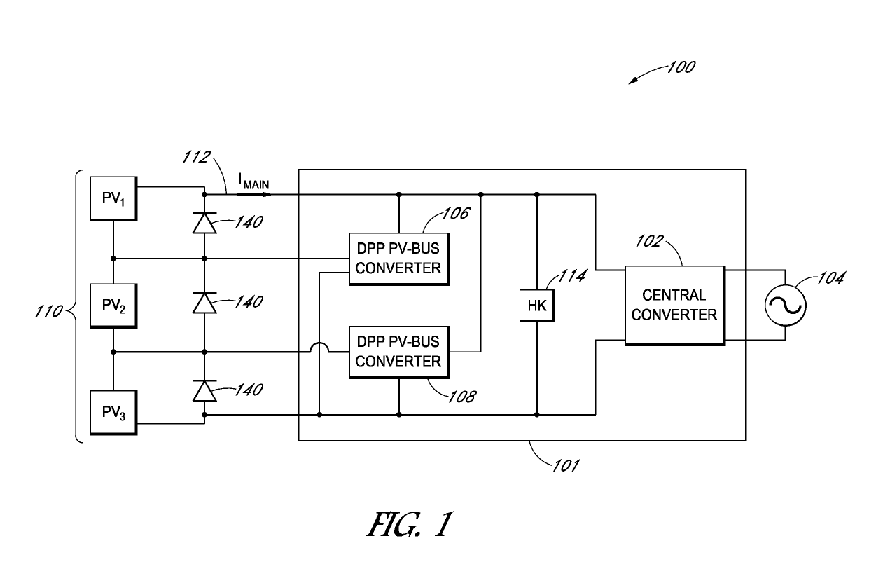

Turning now to FIG. 1, an example block diagram of PV power module 100 having a PV-to-bus module converter 101 is shown. Module converter 101 may be integrated with PV power module 100. Module converter 101 includes a central converter 102. This component may be a dc-ac microinverter, dc-dc converter, dc-dc optimizer, or any other power converter. Central converter 102, and in turn module converter 101, is coupled to alternating current (AC) power system 104.

Module converter 101 also is coupled to PV cell substrings of a PV module 110. The PV cell substrings, designated by PV₁, PV₂ and PV₃, supply solar power to central converter 102. Although three PV cell substrings are shown, the number also may be four or five PV cell substrings, or possible other numbers, in some embodiments. Other embodiments may include a different number of PV cell substrings as well. Preferably, each PV cell substring includes 24 PV cells. Thus, a PV module according to the disclosed embodiments may include 72 PV cells. This is one possible configuration. Other configurations may be implemented. For example, a PV module may include 96 cells, with three PV cell substrings of 24, 48 and 24 cells. In other embodiments, the PV cell substrings may have 20 cells. Thus, not all PV cell substrings need to be equal in the number of cells. As can be appreciated, a variety of configurations of the PV cells and PV cell substrings may be implemented according to the disclosed embodiments. In another example, a PV module with 128 or 256 cells may be used.

DPP PV-to-bus converters 106 and 108 also are integrated within module converter 101. In some embodiments, additional DPP converters may be used for a larger number of PV cell substrings. DPP converters 106 and 108 are both coupled to main bus 112, which couples PV cell substrings 110 to central converter 102. DPP converter 106 is coupled to cell substrings PV₁ and PV₂ to process the mismatch between these cell substrings of PV module 110. DPP converter 108 is coupled to cell substrings PV₂ and PV₃ to process the mismatch between these cell substrings. Mismatches between PV cell substrings may occur when shading, manufacturing variability or non-uniform aging characteristics occurs within a PV module. In some embodiments, the number of DPP converters may correspond to the number of PV cell substrings such that one DPP converter is between two PV cell substrings. In other embodiments, however, the number of DPP converters may be less or not correspond to the number of PV cell substrings. For example, referring to FIG. 1, only the bottom PV cell substring may have a DPP converter and the top two PV cell substrings may just have bypass diodes.

Module converter 101 also includes a housekeeping power supply 114. Housekeeping power supply 114 is a low power supply that runs various sensors, controllers, operational amplifiers, and the like within power module 100. Housekeeping power supply 114 also may run the gate drivers for transistors used in the DPP converters, as disclosed below. In some embodiments, housekeeping power supply 114 may be powered by shared bus 112. In embodiments, as disclosed below, housekeeping power supply 114 may also draw power from various sources within power module 100 or module converter 101 to reduce the requirements for converting a relatively high voltage of main bus 112 to a relatively low voltage.

FIG. 1 also depicts bypass diodes 140. Bypass diodes 140 are optional and as they have little or no impact on the functioning of DPP converters 106 and 108. In fact, bypass diodes may be integrated in DPP converters 106 and 108. Alternatively, bypass diodes 140 may be removed altogether. Further, while conventional diodes are depicted, a Schottky diode or any other device that performs like a diode may be implemented. In some embodiments, so-called “smart diodes” may be used in PV applications.

Module converter 101 has central converter 102 and DPP converters 106 and 108 integrated into a single component. Further, module converter 101 and power module 100 may be integrated, as disclosed by the topologies discussed below. This integration can save cost by not requiring separate circuits or components and sharing some functions between the module and the converters. Space and power processing efficiency also may be increased by the various disclosed DPP topologies as the DPP converters are implemented with a central or shared converter.

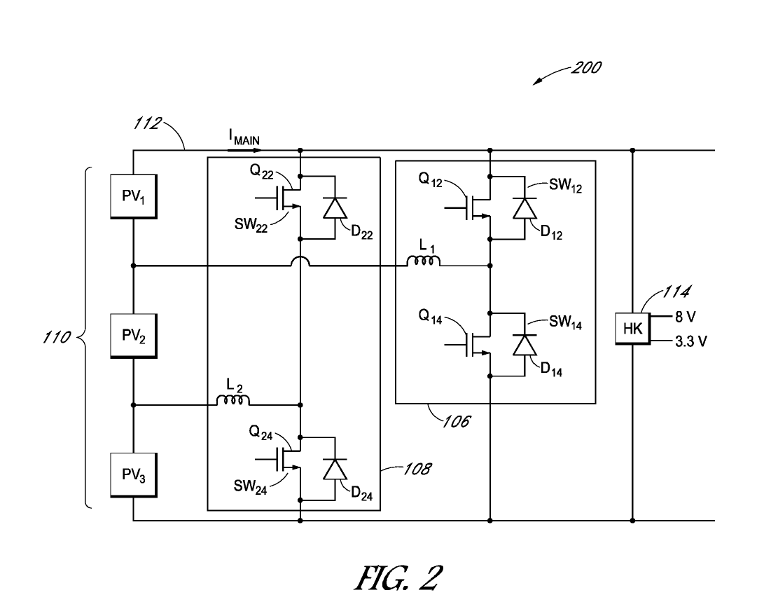

Turning now to FIG. 2, a circuit diagram showing a PV-to-bus converter topology 200 is shown according to some embodiments. PV cell substrings 110 are shown connected to components of DPP converters 106 and 108. Elements of PV power module 100 are included, though not shown, in FIG. 2 where elements of FIG. 1 are configured with the supplemental details of topology 200 to convert and provide power in embodiments.

Each DPP converter shown in FIG. 2 includes two switches and an inductor. Thus, DPP converter 106 includes switches SW₁₂ and SW₁₄ and inductor L₁. DPP converter 108 includes switches SW₂₂ and SW₂₄ and inductor L₂. The switches may be transistor-diode pairs, preferably built from power MOSFETs. For example, switch SW₁₂ may include transistor Q₁₂ and diode D₁₂. Switch SW₁₄, also in DPP converter 106, may include transistor Q₁₄ and diode D₁₄. Switches SW₂₂ and SW₂₄ of DPP converter 108 are similarly configured. In some embodiments, BJTs, IGBTs, HEMTs and other types of semiconductors may be implemented in the DPP converters. Other embodiments may use various structures using silicon and other semiconductors, including silicon carbide or gallium-nitride technologies.

The switches within each DPP converter along with the associated inductor form a bidirectional converter that may exchange power from the PV cell substrings to and from main bus 112, represented as the sum of PV₁-PV₃ cell substrings. The DPP converters also may be connected to a virtual bus. The bidirectional aspect of DPP converters 106 and 108 allows for adjustment of the individual PV cell substring voltages, especially for MPP tracking.

Housekeeping power supply 114 is shown coupled to main bus 112. Housekeeping power supply 114 provides an 8 volt and a 3.3 volt output. In other embodiments, housekeeping power supply 114 may provide other voltages. These voltages may power an integrated microinverter, dc-dc optimizer or other central converter within power module 100. Housekeeping power supply 114 also may power the circuitry of DPP converters 106 and 108. Topology 200 shows housekeeping power supply 114 receiving power from main bus 112. Thus, PV cell substrings 110 may power HKPS 114 using a relatively high voltage (up to 80 volts in some instances; such voltage may increase with a higher number of cells, and the embodiments are not limited to this level).

As taught by FIG. 2, DPP converters 106 and 108 may be integrated with PV cell substrings 110 in power module 100. Inductors within the DPP converters may be attached directly between PV cell substrings without the need for capacitors used for non-integrated module converter. In some embodiments, the inductors may be coupled to each other, though not explicitly shown.

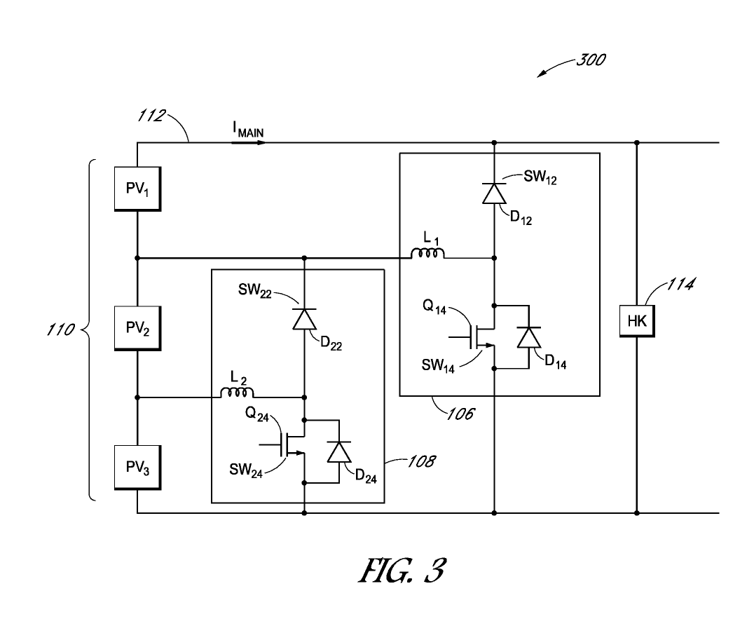

FIG. 3 illustrates a circuit diagram showing a PV-to-bus converter topology 300, according to some embodiments. Converter topology 300 includes PV cell substrings 110, DPP converters 106 and 108, main bus 112 and housekeeping power supply 114. Converter topology 300, however, has the output of DPP converter 108 fed into the output node of PV₂ and the input node of DPP converter 106. Elements of PV power module 100 are included, though not shown, in FIG. 3 where elements of FIG. 1 are configured with the supplemental details of topology 300 to convert and provide power in embodiments.

Further, the DPP converters include diodes for the top switches in converter topology 300. DPP converter 106 implements diode D₁₂ for switch SW₁₂ and DPP converter 108 implements diode D₂₂ for switch SW₂₂. Although the same reference numerals are used for the top switch diodes as those disclosed in converter topology 200, the diodes are not necessarily identical across the converter topologies.

Use of diodes D₁₂ and D₂₂ as the top switches may make DPP converters 106 and 108 unidirectional, as opposed to the bidirectional feature of converter topology 200. DPP converters 106 and 108 in converter topology 300, however, may be lower in cost to produce because the diodes may cost less than transistors, such as MOSFETs. Further, there is no need in this embodiment to provide a high-side gate drive to the top switches of the DPP converters from housekeeping power supply 114.

Switch SW₂₄ may also only need a low voltage blocking requirement as DPP converter 108 is not coupled to shared bus 112. Thus, switch SW₂₄ may provide a lower cost over switch SW₂₄ in converter topology 200. DPP converter 108, in general, may not experience as high of voltage stresses as DPP converter 106 and may be comprised overall of lower cost components.

Another benefit of converter topology 300 is that each of PV cell substrings 110 has a diode at a direct current (DC) implementation. In other words, for DC currents, inductors L₁ and L₂ may be treated as short circuits. This arrangement provides inherent bypass diode protection, especially advantageous if bypass diodes 114 are removed.

Converter topology 300 also is scalable such that any number of DPP converters and PV cell substrings may be implemented. A lower DPP converter may feed into the input node of a higher DPP converter. Thus, DPP converter 108 may feed its output to an input node of another DPP converter. Each PV cell substring would have a parallel diode to provide the advantages disclosed above.

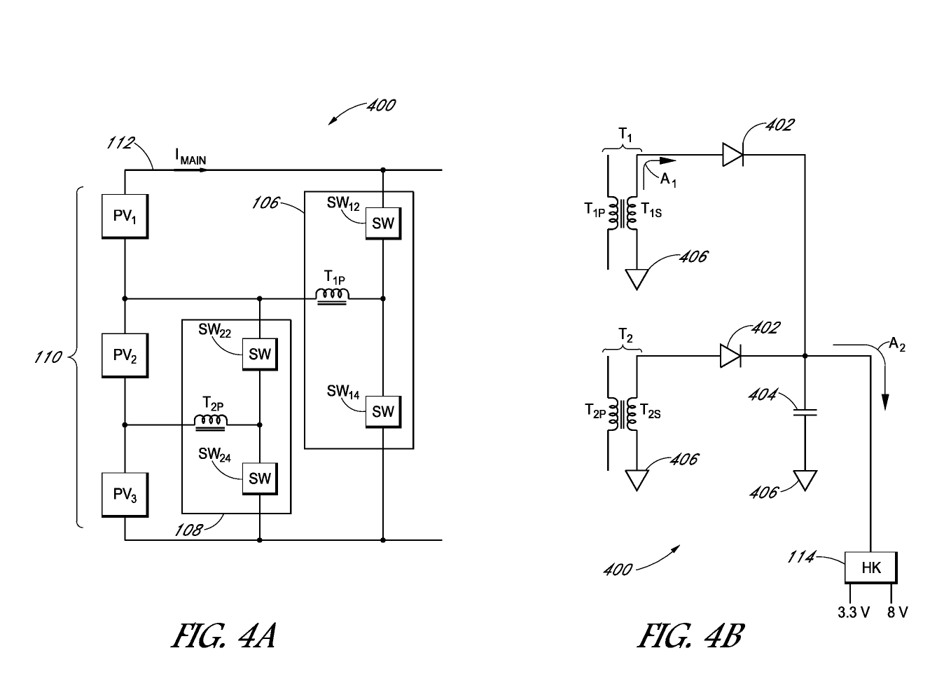

FIGS. 4A and 4B illustrate a circuit diagram showing a PV-to-bus converter topology 400, according to some embodiments. Converter topology 400 may resemble converter topology 300 except that inductors L₁ of DPP converter 106 and L₂ of DPP converter 108 have been replaced by transformer arrangements, shown as transformers T₁ and T₂. DPP converter 106 includes switches SW₁₂ and SW₁₄, as disclosed above, and transformer primary winding T_{1P} of transformer T₁. Transformer primary winding T_{1P} provides the main inductance for power conversion within DPP converter 106. DPP converter 108 includes a similar arrangement with transformer primary winding T_{2P} of transformer T₂. In some embodiments, transformer primary windings T_{1P} and T_{2P} may be referred to as an inductance element. Switches SW₂₂ and SW₂₄ may act as disclosed in previous converter topologies. For the purposes of converter topology 400, the switches may be any of the switch configurations disclosed above. For example, switches SW₁₂ and SW₂₂ may be diodes to provide the unidirectional converters of converter topology 300 or may be the transistor-diodes pairs of converter topology 200 to provide bidirectional converters.

The transformers of DPP converters 106 and 108 may include secondary windings matched to the primary windings. Referring to FIG. 4B, transformer secondary winding T_{1S} is matched to transformer primary winding T_{1P} of DPP converter 106 and transformer secondary winding T_{2S} is matched to transformer primary winding T_{1P} of DPP converter 108 in the secondary portion of converter topology 400. A current in the primary windings of the transformers may generate a magnetic field that impinges on the secondary windings. The magnetic field induces a voltage within the secondary windings.

Thus, as differential power is detected in the PV cell substrings 110, the current flowing through transformer primary windings T_{1P} and T_{2P} may cause a voltage and resulting current (shown by arrows A) to flow. Transformer secondary windings T_{1S} and T_{2S} may be designed to generate a higher or lower current than that flowing in the primary windings. A lower current generates a lower voltage output within the secondary portion of converter topology 400. Transformer secondary windings T_{1S} and T_{2S} may be coupled through diodes 402 or another rectification device to a capacitor 404, or other means to generate a steady DC voltage. Element 406 in FIG. 4B refers to ground.

The DC voltage generated through the transformer secondary windings may be fed to housekeeping power supply 114. Alternatively, the voltage generated by the transformer secondary windings may be stored by other components within the secondary portion of converter topology 400. Housekeeping power supply 114 is disclosed as receiving the lower power from the transformer secondary windings because this configuration may alleviate the need to reduce the large voltage from shared bus 112.

The voltage reduction provided by the transformers T₁ and T₂ may facilitate a capacitor voltage of capacitor 404 that may be similar in value to the desired housekeeping voltage. Preferably, the housekeeping voltage for housekeeping power supply 114 may be lower than the voltage for the full PV module of PV cell substrings 110. It is more efficient to feed housekeeping power supply 114 off of a lower voltage. Thus, the housekeeping circuit of converter topology 400 may be more efficient or simpler than previous topologies.

For example, the housekeeping circuit for housekeeping power supply 114 may replace the high-input-voltage switching power supply with a low-cost linear regulator. Even if a switching power supply is still used, housekeeping power supply 114 of converter topology 400 is fed from a lower voltage source in the transformer secondary windings T_{1S} and T_{2S}, which is lower in cost and more efficient.

Switch SW₁₄ or SW₂₄ switches frequently enough to provide a steady supply of current to transformers T₁ and T₂. Otherwise, housekeeping power may be lost if no current is generated within transformer secondary windings T_{1S} and T_{2S}. For example, if PV₃ is shaded, then no power may be generated in the PV cell substring to flow to transformer primary winding T_{2P}. Alternatively, housekeeping power supply 114 may be fed with the full panel voltage of PV cell substrings 110 via another circuit network as a default so that power is not lost. The housekeeping power supply configuration shown in converter topology 400 may be used only during normal operation or as needed depending on efficiency and availability.

Implementation of a lower voltage to feed housekeeping power supply 114 is desirable to improve efficiency and lower costs. PV cell substrings 110 may have voltages of 30 volts or higher, with 96 cells generating voltages of 50 volts or higher during normal operation. To power 8 volt and 3.3 volt outputs from housekeeping power supply 114, for example, a large step-down conversion may be needed. Converter topology 400 may help provide the lower voltage preferably without the need for the step-down conversion.

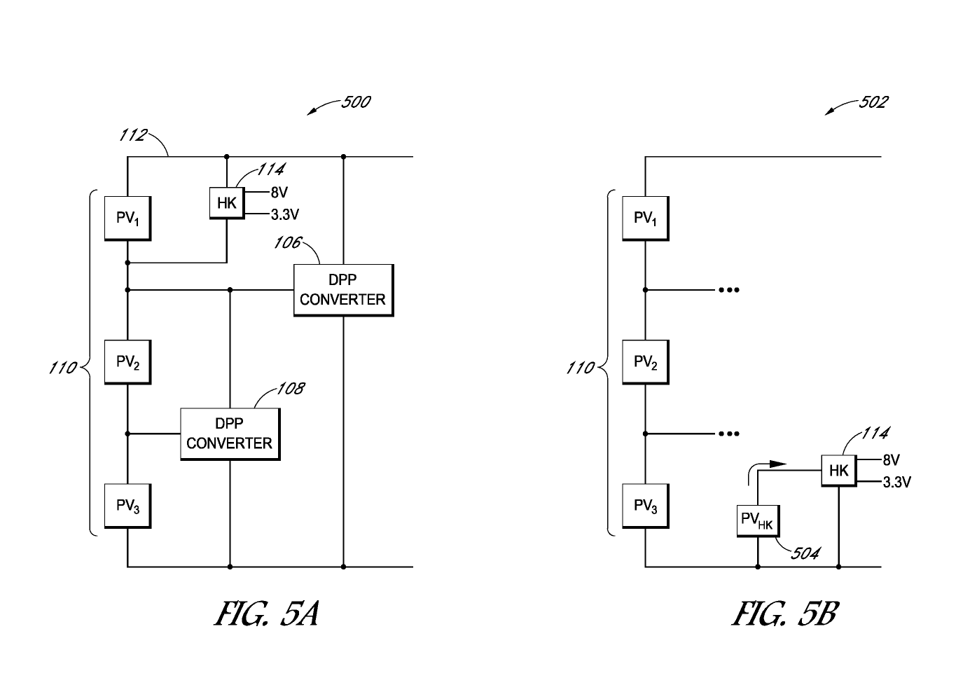

Further, additional topologies may be implemented according to the disclosed embodiments. FIGS. 5A and 5B illustrate a circuit diagram showing PV-to-bus converter topologies 500 and 502, according to some embodiments. Converter topology 500 includes PV cell substrings 110 and DPP converters 106 and 108. The exact configuration of DPP converters 106 and 108 are not shown, but may correspond to the embodiments disclosed above. For example, DPP converter 108 may couple to shared bus 112 instead of the input node of DPP converter 106. Converters 106 and 108 may implement the transistor-diode pair switches of converter topology 200, or the circuits disclosed by converter topologies 300 and 400.

Housekeeping power supply 114 may be powered off a single PV cell substring and provides the desired outputs of 8 volts and 3.3 volts. The disclosed embodiments, however, are not limited to these outputs. In some embodiments, other voltages may be output for gate drive, communications, and logic. FIG. 5A shows the PV cell substring as PV₁, but PV₂ or PV₃ may be used. A PV cell substring may generate an output of about 10-15 volts, which is less than the 30-50 volts output from the entire PV cell substrings 110. Housekeeping power supply 114 may be connected to the top or bottom PV cell substring, or any PV cell substring.

If PV₁ is shaded or otherwise unavailable, then housekeeping power supply 114 may not receive enough power to supply the output voltages. This condition may cause DPP converters 106 and 108 and central converter 102 to shut down. An alternative to converter topology 500 that prevents this condition may be converter topology 502 shown in FIG. 5B.

In converter topology 502, housekeeping power supply 114 preferably is not connected to one of the PV cell substrings in converter topology 502. Instead, housekeeping PV cell 504 is configured to supply power to housekeeping power supply 114. Additional PV cells or even a PV cell substrings may be used to power housekeeping power supply 114, and the embodiments are not limited to one PV cell. For simplicity, the PV cell or plurality of PV cells will be referred to as PV cell 504.

PV cell 504 preferably does not need to be large. More preferably, PV cell 504 may be a 5 or 6 inch cell or other size. PV cell 504 may be placed among the standard cells in a PV cell substring and dedicated to providing power to housekeeping power supply 114. This condition is possible because the power output of PV cell 504 need not be particularly high. In some embodiments, the output power of PV cell 504 may be approximately 0.5 volts.

Alternatively, PV cell 504 may be decoupled from the PV cell substrings, and is its own cell placed on the solar panel array where it will most likely to receive continuous sunlight. As the sun moves during the daylight hours, the upper panels of a solar panel may shade the lower substrings. PV cell 504 may be placed at the top of the panels so that it preferably is not shaded or blocked by the physical construction of the solar panel incorporating PV power module 100. In other embodiments, PV cell 504 may be used when housekeeping power supply 114 does not receive enough power from other means, such as PV cell substrings 110, an individual PV cell substring, or main bus 112.

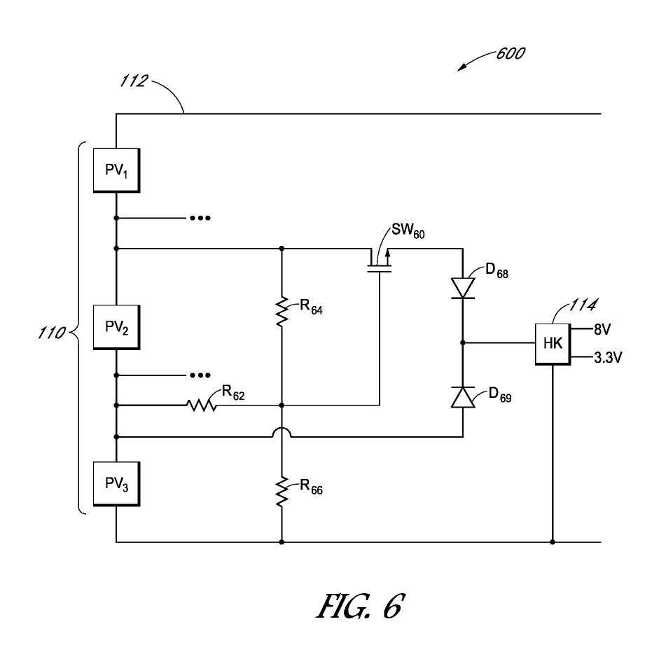

FIG. 6 illustrates a circuit diagram showing PV-to-bus converter topology 600, according to some embodiments. Although not shown, DPP converters 106 and 108 are coupled to PV cell substrings 110 as disclosed above. Converter topology 600 may select the appropriate power source for housekeeping power supply 114. Though not shown, PV cell 504 may be included as a selection source for housekeeping power.

Converter topology 600 uses a network of resistors, diodes and an analog switch to select which of two PV sources connects to the input of housekeeping power supply 114. Resistors R₆₂, R₆₄ and R₆₆ may have resistances to ensure that if PV cell substring PV₃ reduces in voltage, such as below 8 volts, then the sum of the power from PV cell substrings PV₂ and PV₃ is applied to the input of housekeeping power supply 114. This feature enables housekeeping power supply 114 to stay powered even when a PV cell substring or PV cell 504 is shaded or may not be operating efficiently.

Diode D₆₉ allows PV cell substring PV₃ to supply power during normal conditions. Diode D₆₈ provides power when the state (open or closed) of analog switch SW₆₀ determines that not enough power is being provided to housekeeping power supply 114. Preferably, analog switch SW₆₀ is a transistor. In other embodiments, analog switch SW₆₀ may be coupled to PV cell 504, which provides a reliable low power source during shading conditions.

Thus, the disclosed embodiments provide alternate power sources for housekeeping power supply 114. These alternate sources may mitigate the need for converting high voltage from shared bus 112 to the low voltage provided by housekeeping power supply 114. Further, costs may be reduced by integrating housekeeping power supply 114 into module converter 101 or PV power module 100.

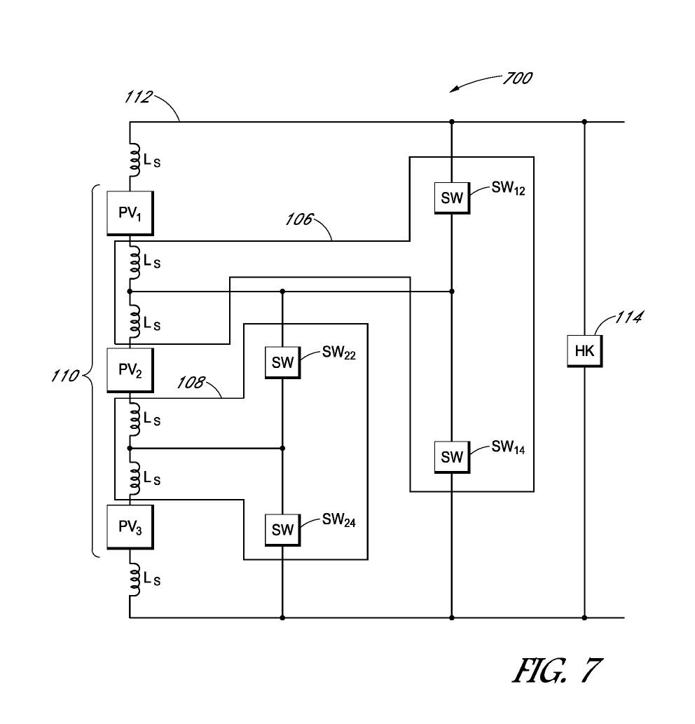

FIG. 7 is a circuit diagram showing PV-to-bus converter topology 700, according to some embodiments. Converter topology 700 includes PV cell substrings 110, DPP converters 106 and 108 and housekeeping power supply 114. The configuration of the circuit may incorporate any of the topologies disclosed above with regard to the placement of the DPP converters and the housekeeping power supply.

Converter topology 700, however, preferably does not use discrete inductors to connect DPP converters 106 and 108 directly to PV cell substrings 110. Instead, the parasitic or stray inductances, shown as inductance elements L_{S} in FIG. 7, of the PV cell substrings may provide the converter inductance. These inductances may be small, such as less than 1 microhenry, but can be adequate for a sufficiently high switching frequency of switches SW₁₄ and SW₂₄.

Moreover, discontinuous converter modes for DPP converters 106 and 108 may be implemented by using diodes for switches SW₁₂ and SW₂₂ as opposed to actively switched power MOSFETS, such as those shown in converter topology 200. In some embodiments, the diode used as a switch may be part of a MOSFET (the body diode of the MOSFET). The MOSFET is turned off so that the diode may conduct. In other embodiments, the MOSFET may be turned on. Thus, though not shown, the DPP converters in topology 200 (and the other topologies) may include a MOSFET for this feature though a diode is shown. Such modes may generate a lot of current ripple in the sources. In other words, the ripple in inductance elements L_{S} would be high. Yet this may not be a problem as solar cells have a relatively high capacitance, such as tens of microfarads. This capacitance may absorb substantially all of high frequency current ripple, which results in very little lost PV power production.

Converter topology 700 may have reduced costs due not using inductors as the inductance elements for the DPP converters. Inductors may be the largest and most expensive component in a DPP converter. By using the parasitic inductances in the PV cell substrings, this cost may be removed. Efficiency, however, also may not be as high as other converter topologies but the DPP converters normally conduct little power compared to the PV cell substrings so that efficiency is not as important.

The converter topologies disclosed above are shown as hard-switched boost converters. The disclosed configurations also work using other converter circuits, particularly if the converters are fed via an inductor. Thus, the disclosed embodiments may be adapted to incorporate other known power converter topologies.

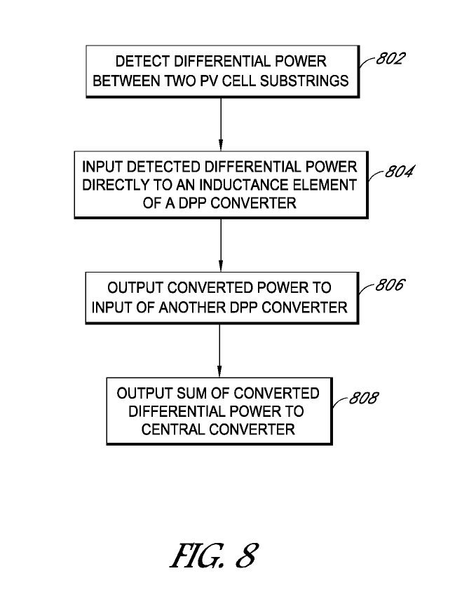

Turning now to FIG. 8, a flowchart illustrating a method for converting differential power within a plurality of PV cell substrings is shown, according to some embodiments. In various embodiments, the method of FIG. 8 can include additional (or fewer) blocks, or steps, than illustrated. Further, where applicable, reference is made to elements shown in the previous figures showing converter topologies. The disclosed topologies, however, are not limited to the steps shown in FIG. 8.

Step 802 executes by detecting differential power between two PV cell substrings. Differential power refers to a mismatch between the power levels found in two PV cell substrings. Preferably, the differential power may be detected by mismatched current or voltage within the PV cell substrings. Referring to FIG. 3, mismatched current or voltage may be detected between PV cell substring PV₂ and PV cell substring PV₃. For example, PV cell substring PV₂ may produce a current of 5 amps while PV cell substring PV₃ produces a current of 6 amps. The difference may be detected in different spots. Depending on the switching state of the converters, the current, voltage or power mismatch may be inferred instead of directly measured.

Step 804 executes by inputting the detected differential power directly to an inductance element of a DPP converter. Staying with the above example, the difference in current may flow to inductor L₂. Alternatively, the differential current may flow through an inductance element, disclosed above. The differential current may flow directly to DPP converter 108. In some embodiments, the detected difference in voltage is used.

Step 806 executes by outputting the converted differential power to an input of another DPP converter. Thus, the output of DPP converter 108 may go to inductor L₁ of DPP converter 106 in some embodiments. In other embodiments, the converted differential power may be output to main bus 112 directly to central converter 102. Again, DPP converters are coupled directly to each other.

This configuration may continue for any number of DPP converters. Thus, the output of DPP converter 106 may be applied to an input node of another DPP converter. Eventually, step 808 executes by outputting the sum, or a part thereof, of the converted differential power to central converter 102 via main bus 112. Some of the converted differential power may be divert back to the PV cells or substrings.

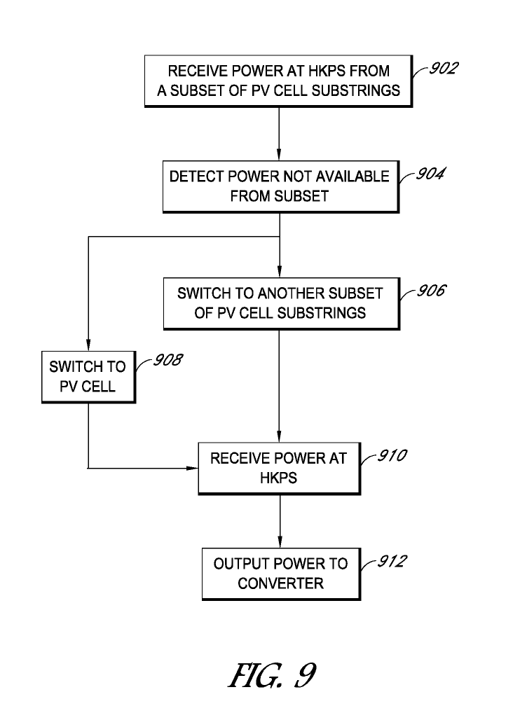

FIG. 9 illustrates a flowchart illustrating a method for supplying power to a housekeeping power supply within a converter topology, according to some embodiments. In various embodiments, the method of FIG. 9 can include additional (or fewer) blocks, or steps, than illustrated. Further, where applicable, reference is made to elements shown in the previous figures showing converter topologies. The disclosed topologies, however, are not limited to the steps shown in FIG. 9.

Step 902 executes by receiving power at housekeeping power supply 114 from a subset of PV cell substrings 110. Preferably, as shown in FIGS. 5A, 5B and 6, the subset may be a single PV cell substrings, a plurality of PV cell substrings, or a dedicated PV cell. The subset indicates that housekeeping power supply 114 preferably is not receiving its power from main bus 112. Thus, the voltage provided to housekeeping power supply 114 may be reduced using the subset.

Step 904 executes by detecting that power preferably is not available from the subset of PV cell substrings. Power may not be available for a variety of reasons, including shading of the solar cells or a malfunction. In this condition, housekeeping power supply 114 may not receive enough power to perform its function to power the converters.

Step 906 executes by switching to another subset of the PV cell substrings. For example, as shown in FIG. 6, power input may be switched to another PV cell substring. Power input is switched to cells that preferably are not shaded or underperforming. Optionally, step 908 may be executed to switch power input to a PV cell dedicated to providing power to housekeeping power supply, as disclosed by converter topology 502. PV cell 504 may be kept in the event that no suitable subset can be found to power housekeeping power supply 114.

Step 910 executes by receiving the voltage at the input of housekeeping power supply 114. As disclosed above, preferably, the voltage is lower in value than using voltage from the main bus. Step 912 executes by outputting the voltage from housekeeping power supply 114 to the DPP converters and the central converter.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure. For example, the DPP converters of embodiments are often shown as hard-switched boost converters. The configurations can work as well using other converter circuits, particularly if they are fed via an inductor (the SEPIC converter, for example). Engineers familiar with power topologies should recognize how to adapt the concepts to other well-known power converter topologies.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A photovoltaic (PV) power converter circuit comprising:
a PV module having a plurality of PV cell substrings, wherein the PV cell substrings are in an arrangement;
a central converter coupled to the PV module by a shared bus;
a number of differential power processing (DPP) converters coupled to the main bus and the plurality of PV cell substrings,
each DPP converter is coupled to two of the plurality of PV cell substrings such that the each of the DPP converters processes a difference in current between the coupled PV cell substrings and provides the processed current difference to the central converter via the shared bus,
the DPP converter comprising two switches and an inductance, wherein the inductance is coupled directed to the plurality of PV cell substrings; and
a housekeeping power supply powered at least in part by the plurality of PV cell substrings, wherein the housekeeping power supply is configured to supply a drive voltage to at least one switch within each DPP converter.

2. The PV power converter circuit of claim 1, wherein the two switches within the DPP converter form a bidirectional converter to exchange power to and from the PV cell substrings and the shared bus.

3. The PV power converter circuit of claim 1, wherein each switch of the two switches within the DPP converter are connected to the housekeeping power supply.

4. The PV power converter circuit of claim 1, wherein each switch of the two switches within the DPP converter includes a diode.

5. The PV power converter circuit of claim 1, wherein the inductance within each switch of the two switches includes a transformer having a primary and secondary winding such that the primary winding is coupled to the plurality of PV cell substrings.

6. The PV power converter circuit of claim 5, wherein the secondary winding supplies power to the housekeeping power supply.

7. The PV power converter circuit of claim 1, wherein the DPP converters include a first DPP converter and a second DPP converter such that a switch of the first DPP converter is coupled to an inductance of the second DPP converter.

8. The PV power converter circuit of claim 7, wherein the second DPP converter is coupled to the shared bus.

9. A photovoltaic (PV) power converter circuit comprising:
a plurality of PV cell substrings configured to provide power through a shared bus;
a central converter to receive the power from the plurality of PV cell substrings through the shared bus;
at least two differential power processing (DPP) converters, wherein each DPP converter includes two switches and an inductance coupled to the plurality of PV cell substrings in the absence of a bypass diode; and
a housekeeping power supply configured to receive power from a subset of all of the plurality of PV cell substrings and to provide power to the central converter and at least one switch in the DPP converters.

10. The PV power converter circuit of claim 9, wherein the inductance includes a transformer having a primary winding and a second winding, and further wherein the primary winding is coupled to the plurality of PV cell substrings.

11. The PV power converter circuit of claim 9, wherein the housekeeping power supply is configured to receive power from a single PV cell substring.

12. The PV power converter circuit of claim 9, further comprising a switching circuit coupled to the housekeeping power supply and the subset of PV cell substrings, wherein the switching circuit is configured to select between a first PV cell substring and a second PV cell substring of the subset of PV cell substrings.

13. The PV power converter circuit of claim 12, wherein the switching circuit selects the second PV cell substring when the first PV cell substring is shaded or not producing power.

14. The PV power converter circuit of claim 9, wherein the subset of the plurality of PV cell substrings is a set aside cell dedicated to supply power to the housekeeping power supply.

15. The PV power converter circuit of claim 14, wherein the set aside cell is electrically decoupled from other cells within the PV cell substring.

16. The PV power converter circuit of claim 9, wherein the housekeeping power supply is integrated with the central converter.

17. The PV power converter circuit of claim 9, wherein the housekeeping power supply supplies a first voltage to the central converter and a second voltage to the switches in the DPP converters.

18. The PV power converter circuit of claim 9, wherein the central converter is a dc-ac converter.

19. The PV power converter circuit of claim 9, wherein the central converter is a dc-dc converter

20. A photovoltaic (PV) power converter circuit connected to a power source, the PV power converter circuit comprising:
a PV module having a plurality of PV cell substrings, wherein the PV cell substrings are in an arrangement;
a central converter coupled to the PV module by a shared bus;
at least one differential power processing (DPP) converter coupled to the shared bus and the plurality of PV cell substrings, the at least one DPP converter configured to process a difference in current between the coupled PV cell substrings and configured to provide the processed current difference to the central converter via the shared bus,
each of the at least one DPP converter comprises two switches and an inductance element, wherein the inductance element for the each of the at least one DPP converter is within a corresponding PV cell substring; and
a housekeeping power supply powered at least in part by the plurality of PV cell substrings, wherein the housekeeping power supply is configured to supply a drive voltage to at least one switch within each DPP converter.

21. The PV power converter circuit connected to a power source of claim 20, wherein the at least one switch includes a transistor and diode having a switching frequency corresponding an inductance of the inductance element.

22. The PV power converter circuit connected to a power source of claim 20, wherein the housekeeping power supply is powered by one PV cell substring.

23. The PV power converter circuit connected to a power source of claim 20, wherein the at least one switch is a top switch within each of the at least one DPP converter, and further wherein the top switch is a diode.

24. The PV power converter circuit connected to a power source of claim 20, wherein the each of the at least one DPP converter includes a first DPP converter and a second DPP converter such that a switch of the first DPP converter is coupled to an inductance element of the second DPP converter.
